(19) United States
(12) Patent Application Publication
(10) Pub. No.: US 2023/0077360 A1
(43) Pub. Date: Mar. 16, 2023

(54) DYNAMIC EDGE COMPUTING WITH RESOURCE ALLOCATION TARGETING AUTONOMOUS VEHICLES

(71) Applicant: INTERNATIONAL BUSINESS MACHINES CORPORATION, Armonk, NY (US)

(72) Inventors: Sarbajit K. Rakshit, Kolkata (IN); Venkata Vara Prasad Karri, Visakhapatnam (IN); Shailendra Moyal, Pune (IN); Akash U. Dhoot, Pune (IN)

(21) Appl. No.: 17/472,200

(22) Filed: Sep. 10, 2021

(51) Int. Cl. G06F 9/50; B60W 60/00; H04W 4/44

(52) U.S. Cl. CPC G06F 9/5072; G06F 9/505; B60W 60/001; H04W 4/44

(57) ABSTRACT

A method for automatically and dynamically allocating edge computing resources to autonomous vehicles is provided. The method may include determining a data processing speed associated with at least one autonomous vehicle. The method may further include automatically determining a computing performance of hardware and software components associated with the at least one autonomous vehicle relative to the computing performance of the hardware and software components of the connected network of autonomous vehicles. The method may further include, automatically identifying at least one edge computing resource necessary for reaching the synchronized threshold level of data processing speed associated with the connected network of autonomous vehicles. The method may further include dynamically allocating the at least one edge computing resource from an edge computing device to the at least one autonomous vehicle based on a location of the at least one autonomous vehicle to the edge computing device.

### BACKGROUND

The present invention relates generally to the field of computing, and more specifically, to edge computing and autonomous vehicles.

Generally, edge computing is a distributed computing framework that brings enterprise computing and applications in closer proximity to data sources such as IoT devices and other computing devices. This proximity to the data source can deliver strong benefits including improved response times for processing data, better bandwidth availability, faster insights into a given computing device, and better scalability compared to cloud computing. For instance, while cloud computing and artificial intelligence (AI) may automate and speed innovation by driving actionable insight from data, the unprecedented scale and complexity of data that is created by connected devices has outpaced network and infrastructure capabilities. More specifically, sending all that device-generated data to a centralized data center or to the cloud may cause bandwidth and latency issues. As such, edge computing offers a more efficient alternative where data is processed and analyzed closer to the point where the data is created. Furthermore, because some of that data may not traverse over a network to a cloud or data center to be processed, latency may be significantly reduced.

### SUMMARY

A method for automatically and dynamically allocating edge computing resources to autonomous vehicles is provided. The method may include determining a data processing speed associated with at least one autonomous vehicle. The method may further include, in response to determining that the data processing speed associated with the at least one autonomous vehicle is below a synchronized threshold level of data processing speed associated with a connected network of autonomous vehicles, automatically determining a computing performance of hardware and software components associated with the at least one autonomous vehicle relative to the computing performance of the hardware and software components of the connected network of autonomous vehicles. The method may further include, based on the determined computing performance of the hardware and software components of the at least one autonomous vehicle, automatically identifying at least one edge computing resource necessary for reaching the synchronized threshold level of data processing speed associated with the connected network of autonomous vehicles. The method may further include in response to identifying the at least one edge computing resource, dynamically allocating the at least one edge computing resource from an edge computing device to the at least one autonomous vehicle based on a proximate location of the at least one autonomous vehicle to the edge computing device.

A computer system for automatically and dynamically allocating edge computing resources to autonomous vehicles is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include determining a data processing speed associated with at least one autonomous vehicle. The method may further include, in response to determining that the data processing speed associated with the at least one autonomous vehicle is below a synchronized threshold level of data processing speed associated with a connected network of autonomous vehicles, automatically determining a computing performance of hardware and software components associated with the at least one autonomous vehicle relative to the computing performance of the hardware and software components of the connected network of autonomous vehicles. The method may further include, based on the determined computing performance of the hardware and software components of the at least one autonomous vehicle, automatically identifying at least one edge computing resource necessary for reaching the synchronized threshold level of data processing speed associated with the connected network of autonomous vehicles. The method may further include in response to identifying the at least one edge computing resource, dynamically allocating the at least one edge computing resource from an edge computing device to the at least one autonomous vehicle based on a proximate location of the at least one autonomous vehicle to the edge computing device.

A computer program product for automatically and dynamically allocating edge computing resources to autonomous vehicles is provided. The computer program product may include one or more computer-readable storage devices and program instructions stored on at least one of the one or more tangible storage devices, the program instructions executable by a processor. The computer program product may include program instructions to determine a data processing speed associated with at least one autonomous vehicle. The computer program product may further include program instructions to, in response to determining that the data processing speed associated with the at least one autonomous vehicle is below a synchronized threshold level of data processing speed associated with a connected network of autonomous vehicles, automatically determining a computing performance of hardware and software components associated with the at least one autonomous vehicle relative to the computing performance of the hardware and software components of the connected network of autonomous vehicles. The computer program product may also include program instructions to, based on the determined computing performance of the hardware and software components of the at least one autonomous vehicle, automatically identifying at least one edge computing resource necessary for reaching the synchronized threshold level of data processing speed associated with the connected network of autonomous vehicles. The computer program product may further include program instructions to, in response to identifying the at least one edge computing resource, dynamically allocating the at least one edge computing resource from an edge computing device to the at least one autonomous vehicle based on a proximate location of the at least one autonomous vehicle to the edge computing device.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 illustrates an expanded view of an edge computing node/device and a computing system associated with an autonomous vehicle in the networked edge computing environment according to one embodiment;

FIG. 3 illustrates an embodiment of a program for automatically and dynamically allocating edge computing resources to autonomous vehicles according to one embodiment;

FIG. 4 is an operational flowchart illustrating the steps carried out by a program for automatically and dynamically allocating edge computing resources to autonomous vehicles according to one embodiment;

FIG. 5 is a block diagram of the system architecture of the program for automatically and dynamically allocating edge computing resources to autonomous vehicles according to one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically and dynamically allocating edge computing resources to autonomous vehicles. Specifically, the following described exemplary embodiments provide a system, method and program product for automatically and dynamically allocating edge computing resources to an autonomous vehicle based on a determination that the autonomous vehicle is experiencing a slower data processing speed that the data processing speed of a connected network of autonomous vehicles. Therefore, the exemplary embodiments have the capacity to improve the functioning of a computer and the technical field associated with autonomous vehicles by using edge computing resources to improve the data processing speed of autonomous vehicles. Specifically, in response to identifying that the data processing speed associated with at least one autonomous vehicle is below a synchronized threshold level of data processing speed associated with the connected network of autonomous vehicles, the method, computer system, and computer program product may determine a computing performance of hardware and software components associated with the at least one autonomous vehicle relative to the computing performance of the hardware and software components of the connected network of autonomous vehicles. Thereafter, based on the determined computing performance of the hardware and software components of the at least one autonomous vehicle, the method, computer system, and computer program product may identify a need for additional edge computing resources for reaching the synchronized threshold level of data processing speed associated with the connected network of autonomous vehicles. In response to identifying the additional edge computing resources, the method, computer system, and computer program product may dynamically allocate the additional edge computing resources from an edge computing device to the at least one autonomous vehicle based on a proximate location of the at least one autonomous vehicle to the edge computing device.

As previously described with respect to edge computing, edge computing may include a distributed computing framework that brings enterprise computing and applications in closer proximity to data sources such as IoT devices. However, for certain IoT devices, such as autonomous vehicles, different autonomous vehicles may have different hardware and software configurations/capabilities such as different versions of operating systems and different processors and memory. As such, in an autonomous vehicle ecosystem that includes the different autonomous vehicles, one or more autonomous vehicles may have different levels of performance when processing data and performing computations, such as when making driving decisions. For example, an autonomous vehicle with faster processing capabilities may make faster driving decisions, such as the decision to accelerate or stop, while another autonomous vehicle with comparatively slower processing capabilities may conversely take longer to process those same driving decisions. In turn, difficulties may arise when synchronizing a speed of the different autonomous vehicles when the different autonomous vehicles are on the same road. More specifically, for example, when the autonomous vehicle ecosystem may be executing synchronous driving between the different autonomous vehicles, such as by issuing a synchronous computing command to stop or decelerate, the comparatively slower autonomous vehicle may take a longer time to stop and consequently cause a collision with a faster autonomous vehicle that may be traveling in front or behind the slower autonomous vehicle. However, by leveraging edge computing, dynamic edge computing resources can be allocated to target autonomous vehicles with lower computing capabilities so that all of the different autonomous vehicles can perform synchronously, for example, by running on the road with a synchronized speed.

Therefore, it may be advantageous, among other things, to provide a method, computer system, and computer program product for automatically and dynamically allocating additional edge computing resources to autonomous vehicles for synchronizing a data processing speed among a connected network of the autonomous vehicles. Specifically, the method, computer system, and computer program product may determine a first level of data processing speed associated with at least one autonomous vehicle by dynamically and recurrently performing comparative analysis and testing of computing performance between the connected network of autonomous vehicles. Furthermore, in response to identifying that the determined first level of data processing speed associated with the at least one autonomous vehicle is below a synchronized threshold level of data processing speed associated with the connected network of autonomous vehicles, the method, computer system, and computer program product may determine a computing performance of hardware and software components associated with the at least one autonomous vehicle relative to the computing performance of the hardware and software components of the connected network of autonomous vehicles. Thereafter, based on the determined computing performance of the hardware and software components of the at least one autonomous vehicle, the method, computer system, and computer program product may identify a need for additional edge computing resources for reaching the synchronized threshold level of data processing speed associated with the connected network of autonomous vehicles. In response to identifying the additional edge computing resources, the method, computer system, and computer program product may dynamically allocate the additional edge computing resources from an edge computing device to the at least one autonomous vehicle based on a proximate location of the at least one autonomous vehicle to the edge computing device.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

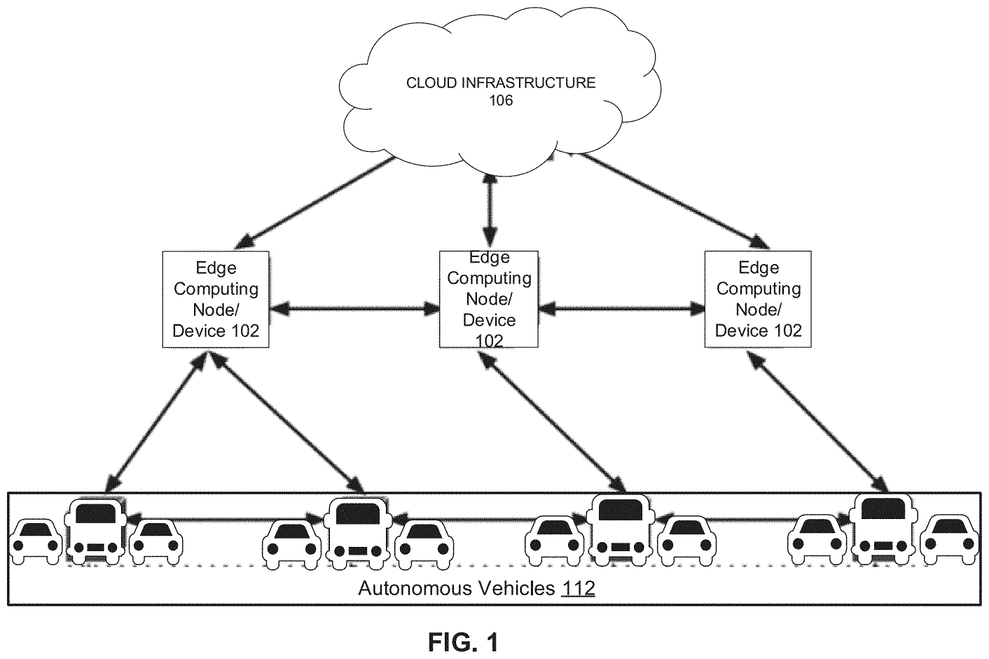

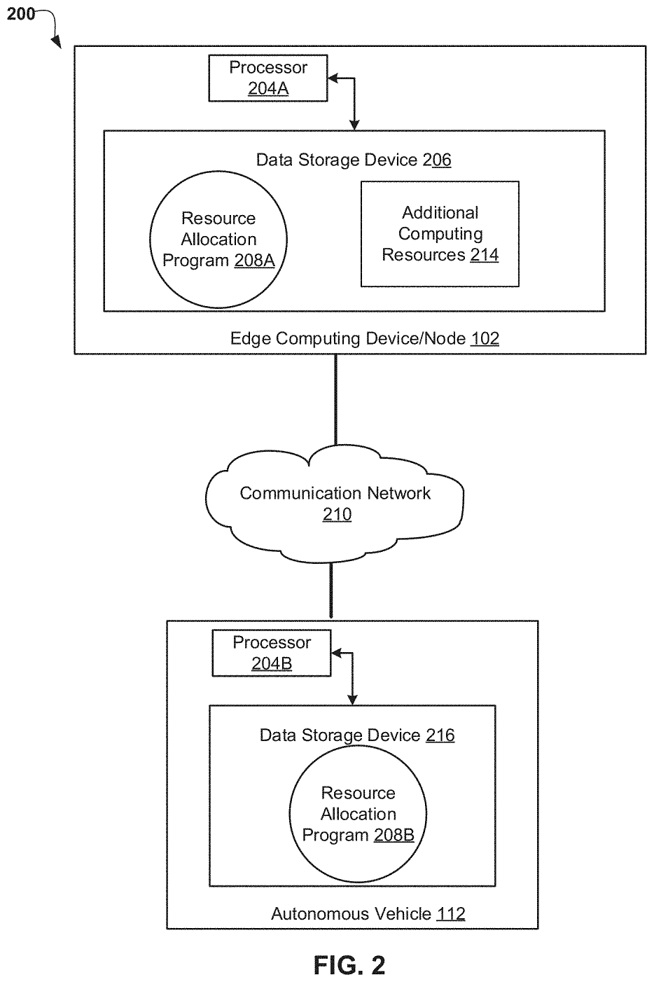

Referring now to FIG. 1, an exemplary networked edge computing environment 100 in accordance with one embodiment is depicted. As will be further described with reference to FIGS. 2 and 5-7, the networked edge computing environment 100 may include a cloud infrastructure 106. Specifically, according to one embodiment, in the networked edge computing environment 100, the cloud infrastructure 106 may serve as long-term storage of on-demand computer system resources, specifically data storage (cloud storage) and computing power, as well as may coordinate immediate lower levels of computing, such as coordinating edge computing nodes/devices 102 with autonomous vehicles 112. The networked edge computing environment 100 may also include edge computing nodes/devices 102 that may include a distributed network of computer devices communicating with each other, the cloud infrastructure 106, and the autonomous vehicles 112 via a communication network (not shown). For example, the communication network may include various types of communication networks, such as a wide area network (WAN), local area network (LAN), a telecommunication network, a wireless network, a public switched network and/or a satellite network. According to one embodiment, the edge computing nodes/devices 102 may be computing base stations and/or edge computing datacenters including computing system resources ranging between routers, switches, processors, computer-readable memories, databases and other storage devices, integrated access devices (IADs), multiplexers, a variety of metropolitan area network (MAN) devices, wide area network (WAN) access devices, and/or one or more software applications. The edge computing nodes/devices 102 may also possess more computing power (when compared to the autonomous vehicles 112) and be capable of routing network traffic between the edge computing nodes/devices 102, between the autonomous vehicles 112, and between the edge computing nodes/devices 102 and the autonomous vehicles 112. As described, the networked edge computing environment 100 may also include autonomous vehicles 112. The autonomous vehicles 112 may be a self-driving vehicle (such as a self-driving car) that may use a combination of sensors, such as IoT sensors, radar, lidar, sonar, GPS, odometry and inertial measurement units, as well as may use computing control systems to interpret sensory information from the sensors to identify appropriate navigation paths and make driving decisions. As such, the autonomous vehicles 112 may include a computer system with computer system resources/components similar to the edge computing nodes/devices 102. For example, the autonomous vehicles 112 may include an operating system, software applications/components, and hardware components such as one or more processors, computer-readable memories, databases and other storage devices, etc. The autonomous vehicles 112 may also communicate with each other as well as with the edge computing nodes/devices 102 and the cloud infrastructure 106 via the communication network described above.

Referring now to FIG. 2, an expanded view 200 of an edge computing node/device 102 and a computing system associated with an autonomous vehicle 112 in the networked edge computing environment 100 (FIG. 1) according to one embodiment is depicted. Specifically, the edge computing node/device 102 may include at least one processor 204A and a data storage device 206 that is enabled to run a resource allocation program 208A and include additional computing system resources 214. The autonomous vehicle 112 may also include a processor 204B along with a data storage device 216 that is enabled to run a resource allocation program 208B. As previously described in FIG. 1, the networked edge computing environment 100 may include a plurality of edge computing nodes/devices 102 and autonomous vehicles 112, only one of each is shown for illustrative brevity in FIG. 2. For example, the plurality of edge computing nodes/devices 102 and autonomous vehicles 112 may include a plurality of interconnected devices.

As previously described with respect to FIG. 1, the communication network 210 may include various types of communication networks, such as a wide area network (WAN), local area network (LAN), a telecommunication network, a wireless network, a public switched network and/or a satellite network. It may be appreciated that FIG. 2 provides only an illustration of one implementation and does not imply any limitations with regard to the environments in which different embodiments may be implemented. Many modifications to the depicted environments may be made based on design and implementation requirements.

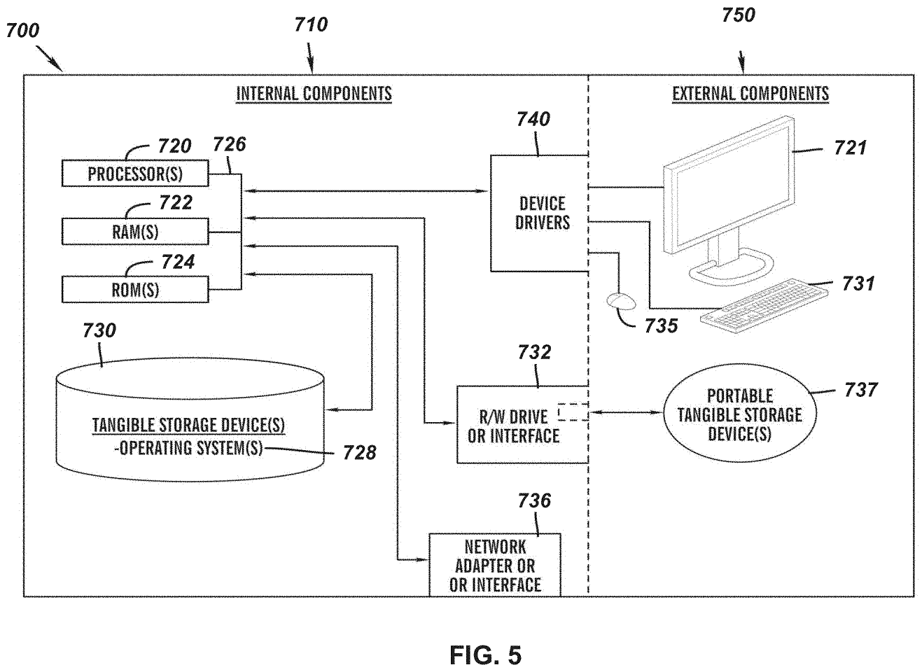

As will be discussed with reference to FIG. 5, edge computing nodes/device 102 and autonomous vehicle 112 may include internal components 710 and possible external components 750. Edge computing nodes/devices 102 and autonomous vehicles 112 may also operate in a cloud computing service model, such as Software as a Service (SaaS), Platform as a Service (PaaS), or Infrastructure as a Service (IaaS). Edge computing nodes/devices 102 and autonomous vehicles 112 may also be located in a cloud computing deployment model, such as a private cloud, community cloud, public cloud, or hybrid cloud. Edge computing node/device 102 may include an edge datacenter, computing base station, edge gateway, and/or a roadside edge device for the autonomous vehicle 112.

According to the present embodiment, a program, such as a resource allocation program 208A and 208B may run on the edge computing node/device 102 and/or on the autonomous vehicles 112 and may communicate via a communications network 210. The resource allocation program 208A, 208B may automatically and dynamically allocate the additional edge computing resources 214 to autonomous vehicles 112 for synchronizing a data processing speed among a connected network of the autonomous vehicles 100 (FIG. 1). For example, the edge computing node/device 102 may run a resource allocation program 208A, 208B, that may interact with the autonomous vehicle 112 to determine a first level of data processing speed associated with the autonomous vehicle 112. Furthermore, in response to identifying that the determined first level of data processing speed associated with the autonomous vehicle 112 is below a synchronized threshold level of data processing speed associated with the connected network of autonomous vehicles, the resource allocation program 208A, 208B may determine a computing performance of hardware and software components associated with the at least one autonomous vehicle. Thereafter, based on the determined computing performance of the hardware and software components of the at least one autonomous vehicle, the resource allocation program 208A, 208B may identify a need for additional edge computing resources for reaching the synchronized threshold level of data processing speed associated with the connected network of autonomous vehicles. In turn, the resource allocation program 208A, 208B may dynamically allocate the additional edge computing resources from an edge computing node/device 102 to the autonomous vehicle 112 based on a proximate location of the autonomous vehicle 112 to the edge computing node/device 102.

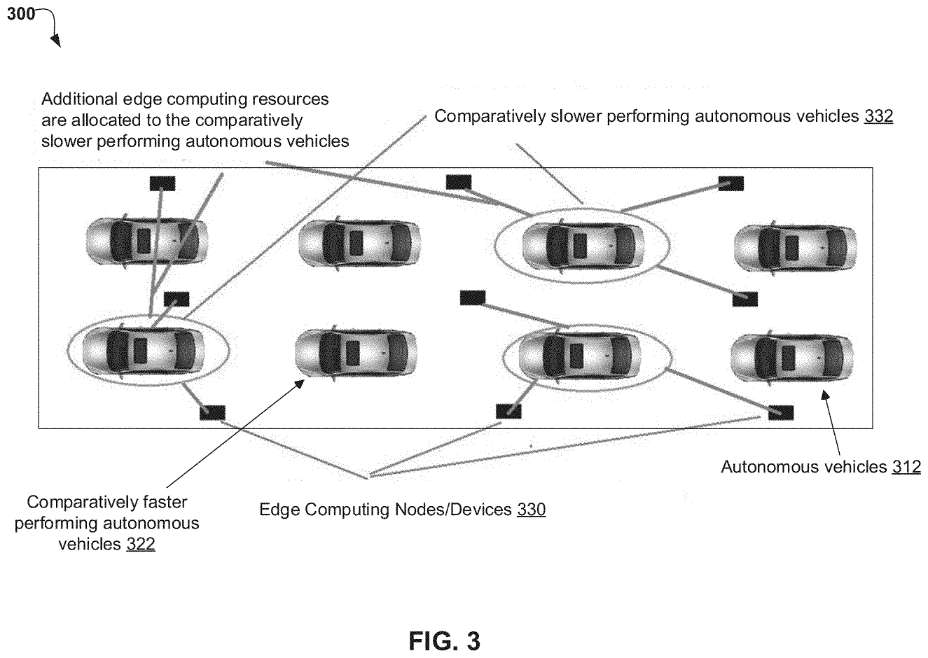

Referring now to FIG. 3, an example diagram 300 illustrating an embodiment of the resource allocation program 208A, 208B (FIG. 2) in a connected network of autonomous vehicles is depicted. Specifically, in FIG. 3, and as previously described with respect to FIG. 1, a connected network of autonomous vehicles 302 may include a group of autonomous vehicles 312, whereby each autonomous vehicle 312 may communicate with an edge computing node/device 330 via a communication network 214 (as previously described in FIG. 2). As previously described, the resource allocation program 208A and 208B may run on the edge computing nodes/devices 330 and/or on the autonomous vehicles 312, respectively. Furthermore, according to one embodiment, the resource allocation program 208A, 208B may synchronize the different autonomous vehicles 312 such that each of the different autonomous vehicles 312 may process data at a same or similar rate/speed. For example, the group of autonomous vehicles 312 may receive a driving instruction to stop. As such, based on the synchronization of the different autonomous vehicles 312, or more specifically, the synchronization of the data processing rate/speed between each of the autonomous vehicles 312, the different autonomous vehicles 312 may receive and process the computer instructions to stop at the same rate and thereby synchronously stop.

However, and as previously described, the different autonomous vehicles 312 may have different types of hardware and software components, configurations, and computing capabilities such as different versions of operating systems, different versions and numbers of processors, different versions and an amount of memory, etc. As such, in the connected network of autonomous vehicles 302 that includes the different autonomous vehicles 312, one or more autonomous vehicles 312 may have different levels of computing performance when processing data and performing computations. For example, and as illustrated in FIG. 3, an autonomous vehicle 322 may have faster data processing capabilities/speed when compared to other autonomous vehicles 332 with comparatively slower data processing capabilities/speed, and therefore, the slower data processing autonomous vehicles 332 may take a longer time to process the same driving instructions/decisions. In turn, difficulties may arise when synchronizing movement and speed of the different autonomous vehicles 312 when the different autonomous vehicles 312 are on a same road and/or traveling in a group. More specifically, for example, when synchronizing the movement between the autonomous vehicles 332 and the autonomous vehicles 322, such as by issuing a synchronous computing command to stop or decelerate, the comparatively slower data processing speed of autonomous vehicles 332 may take a longer time to process the command and consequently cause a collision with the faster autonomous vehicles 322 that may be traveling in front or behind the slower autonomous vehicles 332.

As such, using edge computing nodes/devices 330, the resource allocation program 208A, 208B may dynamically allocate computing resources to the autonomous vehicles 332 experiencing comparatively slower data processing speed. For example, the resource allocation program 208A, 208B may run data processing speed tests on the different autonomous vehicles 312 to determine which autonomous vehicles 312 are processing data at a slower rate when compared to other autonomous vehicles 312. Based on a determination that autonomous vehicle 332 is experiencing the slow data processing speed, the resource allocation program 208A, 208B may identify computing resources that may be necessary for the autonomous vehicle 332 to match the data processing speed of the faster autonomous vehicle 322. For example, the resource allocation program 208A, 208B may include machine learning algorithms that may be used to determine that the slower autonomous vehicle 332 may require more computing resources such as more processors (or processing power) and/or more memory. As such, the resource allocation program 208A, 208B may identify edge computing nodes/devices 330 located near the autonomous vehicle 332 that can provide the necessary computing resources for improving the data processing speed of the autonomous vehicle 332.

According to one embodiment, the edge computing nodes/devices 330 may be situated along a roadside. The resource allocation program 208A, 208B may include a global positioning system (GPS) to identify the location of autonomous vehicles 312 as well as identify edge computing nodes/devices 330 specifically near the autonomous vehicle 332 based on a configurable threshold radius. For example, the resource allocation program 208A, 208B may use a threshold radius of within 100 meters to identify edge computing nodes/devices 330 as near an autonomous vehicle 312. As such, in response to identifying edge computing nodes/devices 330 that are within 100 meters of the autonomous vehicle 332, the resource allocation program 208A, 208B may connect the edge computing nodes/devices 330 to the autonomous vehicle 332. Specifically, the resource allocation program 208A, 208B may use known methods of wirelessly connecting computing devices such as by using access points, satellite communication, mobile communication systems, Bluetooth technology, wireless local area networks, wireless metropolitan area networks, wireless personal area networks and wireless wide area networks. In turn, the resource allocation program 208A, 208B may connect the autonomous vehicle 332 to the computer resources, such as one or more processors and memory, residing on the connected edge computing nodes/devices 330 to supplement and improve the computing performance of the autonomous vehicle 332. As such, the resource allocation program 208A, 208B may use the computer resources on the edge computing nodes/devices 330 to improve the data processing speed of the autonomous vehicle 332 such that the data processing speed of the autonomous vehicle 312 is synchronized with the data processing speed of the previously faster autonomous vehicle 322. As previously described, the resource allocation program 208A, 208B may also enable communication between the edge computing nodes/devices 330 such that the edge computing nodes/devices 330 can communicate with each other. Thus, as the autonomous vehicle 332 moves out of the threshold 100-meter radius of one edge computing node/device 300 into the 100-meter radius of another edge computing node/device 330, the resource allocation program 208A, 208B may automatically hand-off the computer resource allocation to the edge computing nodes/devices 330 that is within the 100 meters. Thus, the resource allocation program 208A, 208B may automatically and continuously provide the necessary computer resources by consecutively connecting edge computing nodes/devices 330 coming within a range of the autonomous vehicle 332, such as within the 100-meter radius of the autonomous vehicle 332.

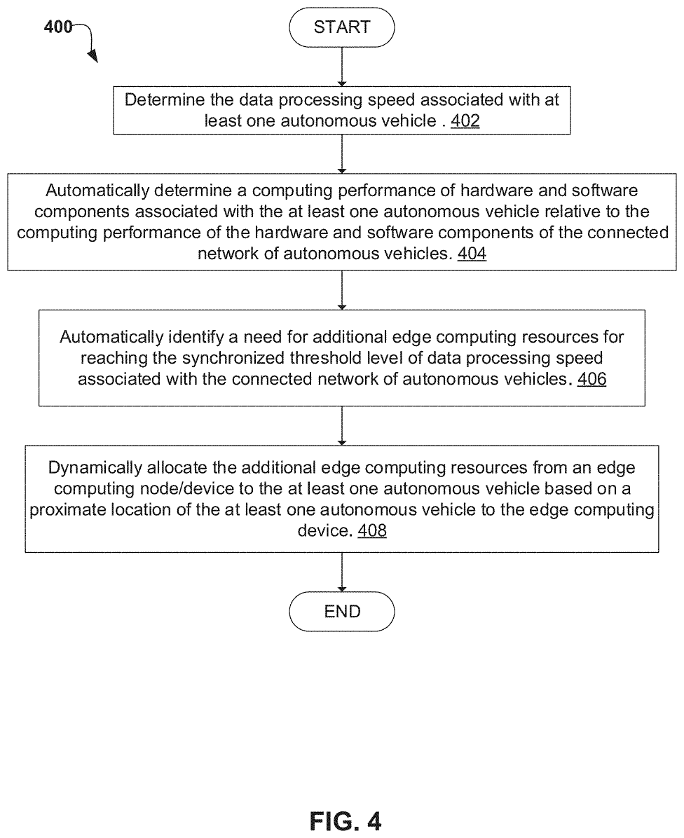

Referring now to FIG. 4, an operational flowchart 400 illustrating the steps carried out by the resource allocation program 208A, 208B for automatically and dynamically allocating additional edge computing resources to autonomous vehicles for synchronizing a data processing speed among a connected network of the autonomous vehicles according to one embodiment is depicted. Specifically, at 402, the resource allocation program 208A, 208B may determine the data processing speed associated with at least one autonomous vehicle by dynamically and recurrently performing comparative analysis and testing of computing performance between the connected network of autonomous vehicles. Specifically, according to one embodiment, the connected network of autonomous vehicles may include multiple autonomous vehicles that may collaborate and communicate with each other via a network. For example, the connected network of autonomous vehicles may move at a collaborative speed and/or make synchronized driving decisions. The resource allocation program 208A, 208B may continuously compare and classify the autonomous vehicles 312 (FIG. 3) based on data processing capability/speed and response time for making driving decisions (such as stop, accelerate, decelerate, etc.). For example, the resource allocation program 208A, 208B may computer run different contextual scenarios on the autonomous vehicles 312 and collect different types of data from the autonomous vehicles based on the computer ran scenarios, such as by collecting hardware and software configuration data of an autonomous vehicle 312 as well as data processing response times. Therefore, the resource allocation program 208A, 208B may determine the data processing speed associated with an autonomous vehicle 312.

Thereafter, at 404, in response to identifying that the determined data processing speed associated with the at least one autonomous vehicle is below a synchronized threshold level of data processing speed associated with the connected network of autonomous vehicles, the resource allocation program 208A, 208B may automatically determine a computing performance of hardware and software components associated with the at least one autonomous vehicle relative to the computing performance of the hardware and software components of the connected network of autonomous vehicles. As previously described with respect to FIG. 3, the different autonomous vehicles 312 may have different types of hardware and software components, configurations, and capabilities such as different versions of operating systems, different versions and numbers of processors, different versions and an amount of memory, etc. As such, in the connected network of autonomous vehicles 302 that includes the different autonomous vehicles 312, one or more autonomous vehicles 312 may have different levels of computing performance when processing data and performing computations. Despite having different hardware and software components, the autonomous vehicles 312 may require synchronization such that the autonomous vehicles 312 process data at a same or synchronized speed/rate. Therefore, in response to identifying that the determined data processing speed associated with the at least one autonomous vehicle is below the synchronized threshold level of data processing speed associated with the connected network of autonomous vehicles, the resource allocation program 208A, 208B may identify the hardware and software components/configuration that may be contributing to the slow data processing speed/rate associated with the at least one autonomous vehicle.

In turn, at 406, based on the determined computing performance of the hardware and software components of the at least one autonomous vehicle, the resource allocation program 208A, 208B may automatically identify a need for additional edge computing resources for reaching the synchronized threshold level of data processing speed associated with the connected network of autonomous vehicles. Specifically, based on a determination that the at least autonomous vehicle is experiencing the slow data processing speed, the resource allocation program 208A, 208B may analyze the autonomous vehicle to identify computing resources that may be necessary for the autonomous vehicle to match the required data processing speed of the connected network of autonomous vehicles. For example, and as previously described in FIG. 3, the resource allocation program 208A, 208B may include machine learning algorithms that may be used to determine that a slower autonomous vehicle may require more computing resources, such as additional memory, so that the autonomous vehicle will have more processing power.

As such, at 408, in response to identifying the necessary additional edge computing resources, the resource allocation program 208A, 208B may dynamically allocate the additional edge computing resources from an edge computing node/device to the at least one autonomous vehicle based on a proximate location of the at least one autonomous vehicle to the edge computing device. As previously described in FIG. 3, and according to one embodiment, the edge computing nodes/devices 330 may be situated along a roadside. The resource allocation program 208A, 208B may include a global positioning system (GPS) to identify the location of autonomous vehicles 312 as well as identify edge computing nodes/devices 330 specifically near the autonomous vehicle 332 experiencing slower processing times based on a configurable threshold radius. For example, and as previously described, the resource allocation program 208A, 208B may use a threshold radius of within 100 meters to identify edge computing nodes/devices as near an autonomous vehicle. As such, in response to identifying edge computing nodes/devices that are within 100 meters of the autonomous vehicle, the resource allocation program 208A, 208B may connect the edge computing nodes/devices to the autonomous vehicle. In turn, the resource allocation program 208A, 208B may connect the autonomous vehicle to the additional edge computing resources such as by connecting the autonomous vehicle to one or more processors and memory residing on the connected edge computing nodes/devices to supplement and improve the computing performance of the autonomous vehicle. As such, the resource allocation program 208A, 208B may use the computer resources on the edge computing nodes/devices to improve the data processing speed of the autonomous vehicle such that the data processing speed of the autonomous vehicle is synched/synchronized with the data processing speed of the connected network of autonomous vehicles that had previously faster data processing speeds. As previously described, the edge computing nodes/devices 330 may also communicate with each other. Thus, as the autonomous vehicle 332 moves out of the threshold 100-meter radius of one edge computing node/device 300 into the 100-meter radius of another edge computing node/device 330, the resource allocation program 208A, 208B may automatically hand-off the computer resource allocation to the edge computing nodes/devices 330 that is within the 100 meters. Thus, the resource allocation program 208A, 208B may automatically and continuously provide the necessary computer resources to the autonomous vehicle as the autonomous vehicle moves by continuously connecting edge computing nodes/devices within the radius of the autonomous vehicle. According to one embodiment, the resource allocation program 208A, 208B may also rearrange a position of the autonomous vehicle experiencing slower data processing times. For example, based on the slower data processing speed, the resource allocation program 208A, 208B may move the autonomous vehicle with the slower data processing speed from a middle of a group of autonomous vehicles to a rear of the group of autonomous vehicles so that the slower autonomous vehicle does not interfere with the other autonomous vehicles. Therefore, the resource allocation program 208A, 208B may reposition autonomous vehicles based on the data processing capabilities/speed of the autonomous vehicles.

Furthermore, the resource allocation program 208A, 208B may historically track the additional edge computing resources that are allocated to the different autonomous vehicles to generate future recommendations for deploying the additional edge computing resources on the autonomous vehicles. For example, the resource allocation program 208A, 208B may use machine learning algorithms to track that a certain autonomous vehicle always requires additional memory for improving the data processing speed of that certain autonomous vehicle. As such, the resource allocation program 208A, 208B may plan and/or recommend a plan to deploy additional memory on that certain autonomous vehicle when that certain autonomous vehicle is on the road. The resource allocation program 208A, 208B may also track the deployed additional edge computing resources on the autonomous vehicles based on other criteria such as location information and based on certain driving decisions made by the autonomous vehicles. For example, the resource allocation program 208A, 208B may track that a certain autonomous vehicle may require additional memory during a certain location on the road, and/or may require additional memory when making a certain driving decision (such as stop). Thus, the resource allocation program 208A, 208B may plan and/or recommend a plan to deploy additional memory on that certain autonomous vehicle when such criterion is met.

It may be appreciated that FIGS. 1-4 provide only illustrations of one implementation and does not imply any limitations with regard to how different embodiments may be implemented. Many modifications to the depicted environments may be made based on design and implementation requirements.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

FIG. 5 is a block diagram 700 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 710 and 750 is representative of any electronic device capable of executing machine-readable program instructions that may include an edge computing node/device computer (710 and 750) and/or an autonomous vehicle (710 and 750). Data processing system 710 and 750 may be representative of a computer system or other electronic devices. Examples of computing systems, environments, and/or configurations that may represented by data processing system 710 and 750 may include, but are not limited to, autonomous vehicles, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

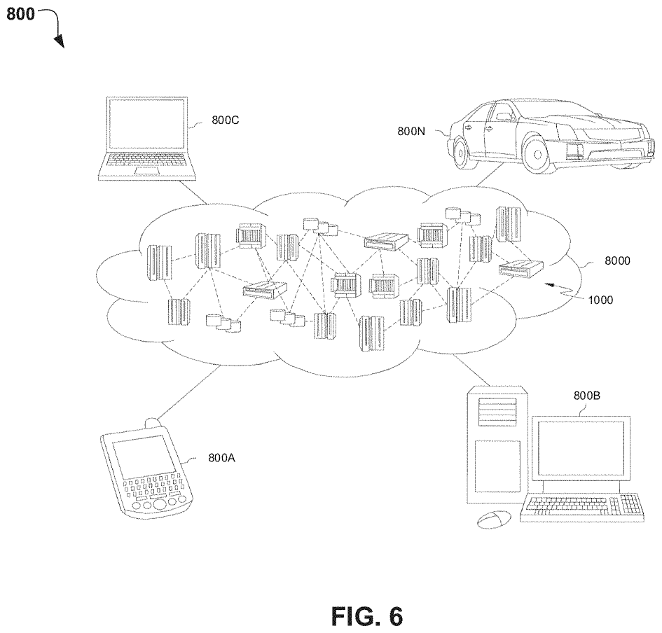

Edge computing node/device 102 (FIG. 2) and autonomous vehicle 112 (FIG. 2) may include respective sets of internal components 710 and external components 750 illustrated in FIG. 6. Each of the sets of internal components 710 includes one or more processors 720, one or more computer-readable RAMs 722, and one or more computer-readable ROMs 724 on one or more buses 726, and one or more operating systems 728 and one or more computer-readable tangible storage devices 730. The one or more operating systems 728 and the resource allocation program 208A (FIG. 2) in edge computing node/device 102 (FIG. 2), and the resource allocation program 208B (FIG. 1) in autonomous vehicle 112 (FIG. 2) are stored on one or more of the respective computer-readable tangible storage devices 730 for execution by one or more of the respective processors 720 via one or more of the respective RAMs 722 (which typically include cache memory). In the embodiment illustrated in FIG. 5, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 710, also includes a R/W drive or interface 732 to read from and write to one or more portable computer-readable tangible storage devices 737 such as a CD-ROM, DVD, memory stick, magnetic tape, magnetic disk, optical disk or semiconductor storage device. A software program, such as a resource allocation program 208A and 208B (FIG. 1), can be stored on one or more of the respective portable computer-readable tangible storage devices 737, read via the respective R/W drive or interface 732, and loaded into the respective hard drive 730.

Each set of internal components 710 also includes network adapters or interfaces 736 such as a TCP/IP adapter cards, wireless Wi-Fi interface cards, or 3G or 4G wireless interface cards or other wired or wireless communication links. The resource allocation program 208A (FIG. 1) in edge computing node/device 102 (FIG. 2), and the resource allocation program 208B (FIG. 2) in autonomous vehicle 112 (FIG. 2) can be downloaded to the edge computing node/device 102 (FIG. 2) from an external computer via a network (for example, the Internet, a local area network or other, wide area network) and respective network adapters or interfaces 736. From the network adapters or interfaces 736, the resource allocation program 208A (FIG. 2) in edge computing node/device 102 (FIG. 1) and the resource allocation program 208B (FIG. 2) in autonomous vehicle 112 (FIG. 2) are loaded into the respective hard drive 730. The network may comprise copper wires, optical fibers, wireless transmission, routers, firewalls, switches, gateway computers, and/or edge servers.

Each of the sets of external components 750 can include a computer display monitor 721, a keyboard 731, and a computer mouse 735. External components 750a, b can also include touch screens, virtual keyboards, touch pads, pointing devices, and other human interface devices. Each of the sets of internal components 710 also includes device drivers 740 to interface to computer display monitor 721, keyboard 731, and computer mouse 735. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

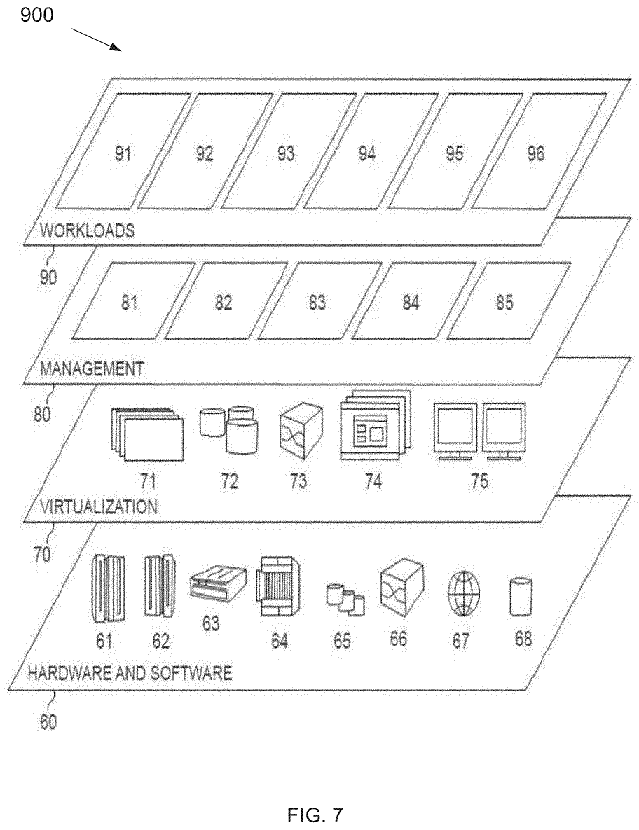

Referring now to FIG. 6, illustrative cloud computing environment 800 is depicted. As shown, cloud computing environment 800 comprises one or more cloud computing nodes 1000 with which local computing devices used by cloud consumers, such as, for example, personal digital assistant (PDA) or cellular telephone 800A, desktop computer 800B, laptop computer 800C, and/or automobile computer system 800N may communicate. Nodes 1000 may communicate with one another. They may be grouped (not shown) physically or virtually, in one or more networks, such as Private, Community, Public, or Hybrid clouds as described hereinabove, or a combination thereof. This allows cloud 8000 to offer infrastructure, platforms and/or software as services for which a cloud consumer does not need to maintain resources on a local computing device. It is understood that the types of computing devices 800A-N shown in FIG. 7 are intended to be illustrative only and that computing nodes 100 and cloud 8000 can communicate with any type of computerized device over any type of network and/or network addressable connection (e.g., using a web browser).

Referring now to FIG. 7, a set of functional abstraction layers 900 provided by cloud computing environment 800 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Resource allocation 96. A resource allocation program 208A, 208B (FIG. 1) may be offered “as a service in the cloud” (i.e., Software as a Service (SaaS)) for applications running on computing devices 102 (FIG. 1) and may automatically and dynamically allocate edge computing resources to autonomous vehicles.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for automatically and dynamically allocating edge computing resources to autonomous vehicles, comprising:
determining a data processing speed associated with at least one autonomous vehicle;
in response to determining that the data processing speed associated with the at least one autonomous vehicle is below a synchronized threshold level of data processing speed associated with a connected network of autonomous vehicles, automatically determining a computing performance of hardware and software components associated with the at least one autonomous vehicle relative to the computing performance of the hardware and software components of the connected network of autonomous vehicles;
based on the determined computing performance of the hardware and software components of the at least one autonomous vehicle, automatically identifying at least one edge computing resource necessary for reaching the synchronized threshold level of data processing speed associated with the connected network of autonomous vehicles such that the at least one autonomous vehicle processes data at the synchronized level of data processing speed as the connected network of autonomous vehicles; and
in response to identifying the at least one edge computing resource, dynamically allocating the at least one edge computing resource from an edge computing device to the at least one autonomous vehicle based on a proximate location of the at least one autonomous vehicle to the edge computing device.

2. The computer-implemented method of claim 1, wherein dynamically allocating the at least one edge computing resource from the edge computing device to the at least one autonomous vehicle further comprises:
identifying a location of the at least one autonomous vehicle;
identifying at least one edge computing device within a threshold radius of the location of the at least one autonomous vehicle; and
allocating the at least one edge computing resource on the at least one edge computing device to the at least one autonomous vehicle by connecting the at least one edge computing device to the at least one autonomous vehicle while the at least one autonomous vehicle is within the threshold radius.

3. The computer-implemented method of claim 1, wherein determining a data processing speed associated with the at least one autonomous vehicle further comprises:
dynamically and recurrently performing comparative analysis and testing of the computing performance between the connected network of autonomous vehicles.

4. The computer-implemented method of claim 1, wherein determining a computing performance of hardware and software components associated with the at least one autonomous vehicle further comprises:
identifying at least one of an operating system, hardware configuration, and software configuration associated with the at least one autonomous vehicle.

5. The computer-implemented method of claim 1, further comprising:
synching the data processing speed of the at least one autonomous vehicle with the synchronized threshold level of data processing speed associated with the connected network of autonomous vehicles in response to dynamically allocating the at least one edge computing resource.

6. The computer-implemented method of claim 1, further comprising:
historically tracking the allocation of the at least one edge computing resource to generate recommendations for allocating the at least one edge computing resource to the autonomous vehicles.

7. The computer-implemented method of claim 1, further comprising:
repositioning the at least one autonomous vehicle in the connected network of autonomous vehicles based on the determination that the data processing speed associated with the at least one autonomous vehicle is below the synchronized threshold level of data processing speed associated with the connected network of autonomous vehicles.

8. A computer system for automatically and dynamically allocating edge computing resources to autonomous vehicles, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
determining a data processing speed associated with at least one autonomous vehicle;
in response to determining that the data processing speed associated with the at least one autonomous vehicle is below a synchronized threshold level of data processing speed associated with a connected network of autonomous vehicles, automatically determining a computing performance of hardware and software components associated with the at least one autonomous vehicle relative to the computing performance of the hardware and software components of the connected network of autonomous vehicles;
based on the determined computing performance of the hardware and software components of the at least one autonomous vehicle, automatically identifying at least one edge computing resource necessary for reaching the synchronized threshold level of data processing speed associated with the connected network of autonomous vehicles such that the at least one autonomous vehicle processes data at the synchronized level of data processing speed as the connected network of autonomous vehicles; and
in response to identifying the at least one edge computing resource, dynamically allocating the at least one edge computing resource from an edge computing device to the at least one autonomous vehicle based on a proximate location of the at least one autonomous vehicle to the edge computing device.

9. The computer system of claim 8, wherein dynamically allocating the at least one edge computing resource from the edge computing device to the at least one autonomous vehicle further comprises:
identifying a location of the at least one autonomous vehicle;
identifying at least one edge computing device within a threshold radius of the location of the at least one autonomous vehicle; and
allocating the at least one edge computing resource on the at least one edge computing device to the at least one autonomous vehicle by connecting the at least one edge computing device to the at least one autonomous vehicle while the at least one autonomous vehicle is within the threshold radius.

10. The computer system of claim 8, wherein determining a data processing speed associated with the at least one autonomous vehicle further comprises:
dynamically and recurrently performing comparative analysis and testing of the computing performance between the connected network of autonomous vehicles.

11. The computer system of claim 8, wherein determining a computing performance of hardware and software components associated with the at least one autonomous vehicle further comprises:
identifying at least one of an operating system, hardware configuration, and software configuration associated with the at least one autonomous vehicle.

12. The computer system of claim 8, further comprising:
synching the data processing speed of the at least one autonomous vehicle with the synchronized threshold level of data processing speed associated with the connected network of autonomous vehicles in response to dynamically allocating the at least one edge computing resource.

13. The computer system of claim 8, further comprising:
historically tracking the allocation of the at least one edge computing resource to generate recommendations for allocating the at least one edge computing resource to the autonomous vehicles.

14. The computer system of claim 8, further comprising:
repositioning the at least one autonomous vehicle in the connected network of autonomous vehicles based on the determination that the data processing speed associated with the at least one autonomous vehicle is below the synchronized threshold level of data processing speed associated with the connected network of autonomous vehicles.

15. A computer program product for automatically and dynamically allocating edge computing resources to autonomous vehicles, comprising:
one or more tangible computer-readable storage devices and program instructions stored on at least one of the one or more tangible computer-readable storage devices, the program instructions executable by a processor, the program instructions comprising:
determining a data processing speed associated with at least one autonomous vehicle;
in response to determining that the data processing speed associated with the at least one autonomous vehicle is below a synchronized threshold level of data processing speed associated with a connected network of autonomous vehicles, automatically determining a computing performance of hardware and software components associated with the at least one autonomous vehicle relative to the computing performance of the hardware and software components of the connected network of autonomous vehicles;
based on the determined computing performance of the hardware and software components of the at least one autonomous vehicle, automatically identifying at least one edge computing resource necessary for reaching the synchronized threshold level of data processing speed associated with the connected network of autonomous vehicles such that the at least one autonomous vehicle processes data at the synchronized level of data processing speed as the connected network of autonomous vehicles; and
in response to identifying the at least one edge computing resource, dynamically allocating the at least one edge computing resource from an edge computing device to the at least one autonomous vehicle based on a proximate location of the at least one autonomous vehicle to the edge computing device.

16. The computer program product of claim 15, wherein dynamically allocating the at least one edge computing resource from the edge computing device to the at least one autonomous vehicle further comprises:
identifying a location of the at least one autonomous vehicle;
identifying at least one edge computing device within a threshold radius of the location of the at least one autonomous vehicle; and
allocating the at least one edge computing resource on the at least one edge computing device to the at least one autonomous vehicle by connecting the at least one edge computing device to the at least one autonomous vehicle while the at least one autonomous vehicle is within the threshold radius.

17. The computer program product of claim 15, wherein determining a computing performance of hardware and software components associated with the at least one autonomous vehicle further comprises:
identifying at least one of an operating system, hardware configuration, and software configuration associated with the at least one autonomous vehicle.

18. The computer program product of claim 15, further comprising:
synching the data processing speed of the at least one autonomous vehicle with the synchronized threshold level of data processing speed associated with the connected network of autonomous vehicles in response to dynamically allocating the at least one edge computing resource.

19. The computer program product of claim 15, further comprising:
historically tracking the allocation of the at least one edge computing resource to generate recommendations for allocating the at least one edge computing resource to the autonomous vehicles.

20. The computer program product of claim 15, further comprising:
repositioning the at least one autonomous vehicle in the connected network of autonomous vehicles based on the determination that the data processing speed associated with the at least one autonomous vehicle is below the synchronized threshold level of data processing speed associated with the connected network of autonomous vehicles.
